(19) United States
(12) Patent Application Publication
(10) Pub. No.: US 2018/0060924 A1
(43) Pub. Date: Mar. 1, 2018

(54) System and Method of Interactive Consumer Marketing

(71) Applicant: Brad Steinwede, New York, NY (US)

(72) Inventor: Brad Steinwede, New York, NY (US)

(21) Appl. No.: 15/805,076

(22) Filed: Nov. 6, 2017

Related U.S. Application Data
(63) Continuation-in-part of application No. 13/935,409, filed on Jul. 3, 2013, now abandoned.
Application No. 13/935,409 is a division of application No. 12/363,150, filed on Jan. 30, 2009, now abandoned.
(60) Provisional application No. 61/063,807, filed on Feb. 5, 2008.

(51) Int. Cl. G06Q 30/02; H04N 21/81

(52) U.S. Cl. CPC G06Q 30/0277; H04N 21/8173; G06Q 30/0225; G06Q 30/02; G06Q 30/0203; H04N 21/812

(57) ABSTRACT

A private first challenge can be conducted within a consumer engagement mobile application. A component of the challenge can be a good or a service of the sponsor. Each participant in the challenge must complete an act involving the good or the service component. Each participant must create a visual record of the act. The participants must submit the visual record of the act at a first specified time period. An invitation can be conveyed to participate in the challenge to each participant valid for the duration of the time period. Advantageously, all within the mobile application, private challenges/contests are provided, which allow users and sponsors to generate and set the terms of their own challenge/contest, as well as allow users and sponsors to engage in multiple concurrent challenges/contests.

### CROSS REFERENCE TO RELATED APPLICATIONS

This is U.S. Continuation-in-Part application claiming priority to and the benefit of currently pending U.S. Divisional patent application Ser. No. 13/935,409, filed Jul. 3, 2013, which claims priority to and the benefit of now abandoned U.S. patent application Ser. No. 12/363,150, filed Jan. 30, 2009, which claims priority to and the benefit of U.S. Provisional Patent Application 61/063,807, filed Feb. 5, 2008, now abandoned.

### STATEMENT REGARDING FEDERALLY SPONSORED RESEARCH OR DEVELOPMENT

Not Applicable.

### REFERENCE TO A MICROFICHE APPENDIX

Not Applicable.

### COPYRIGHT NOTICE

A portion of the disclosure of this patent document may contain material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

Additionally, this patent document may contain material which is subject to contest or competition sponsorship regulations. Therefore, because such regulations are not the focus of this document, it is anticipated that if such regulation were deemed to apply, appropriate components of the system and method of interactive consumer marketing as described herein would be conformable thereto, according to the understanding of one skilled in the art.

### BACKGROUND OF THE DISCLOSURE

### Technical Field

The present disclosure relates generally to marketing methods and, more specifically, to a system and method of interactive consumer marketing encouraging repeated consumer access and consumer viewing of a mobile application providing target and/or sponsor-branding, collecting consumer database contact information, accomplishing physical presentment of and/or emotionally engaged experience with a target/sponsor product or service, and encouraging live consumer-driven, action media attention and broadcast focus referencing a target/sponsor, while allowing for cost-effective and short-term commitment of a target/sponsor. Advantageously, the present disclosure operates entirely on a mobile application having the proprietary name TA-DAH®. Advantageously, all within the mobile application, private challenges/contests are provided, which allow users and sponsors to generate and set the terms of their own challenge/contest, as well as allow users and sponsors to engage in multiple concurrent challenges/contests. The mobile application is a self-contained marketing tool. All challenges/events, functions, consumer-interaction, video display, voting, etc. occurs directly on the mobile application and not a host website.

### Prior Art

In the United States, companies and financial entities have been reported to annually spend in excess of $1.5 billion in mobile application advertising, and in excess of $145 billion in overall product advertising. Worldwide, undoubtedly the total of such expenditures is staggering; and the figures keep growing. In fact, according to recent reports, in the third quarter of 2008, U.S. Internet advertising rose approximately 25% as compared to the same period in 2007, totaling more than $5.2 billion.

Recognizing these costs, along with technological advancements enabling the availability of the collection and transmission of electronic data and information in many forms, businesses have developed a variety of systems and methods for utilizing electronic mobile application accesses, or hits, as sources of consumer database information. Such database information facilitates more targeted direction of advertising materials. However, while collecting consumer information at a mobile application can be successful, the consumer must first choose to access the site.

### BRIEF SUMMARY OF THE DISCLOSURE

The present disclosure meets the above-mentioned needs by providing at least one of a system, method, and computer program product for providing a mobile application for consumer engagement with products/services via one or more of a sponsored challenge and a private challenge including a graphical user interface that encourages user interaction. Private challenges may be utilized for sponsored challenges and/or events, but they can also be used by any user to interact (play) with their own friends and/or community, for example. The mobile application is a self-contained marketing tool. All challenges/events, functions, consumer-interaction, video display, voting, etc. occurs directly on the mobile application and not a host website. Advantageously, all within the mobile application, private challenges/contests are provided, which allow users and sponsors to generate and set the terms of their own challenge/contest, as well as allow users and sponsors to engage in multiple concurrent challenges/contests.

According to its major aspects and broadly stated, the present disclosure is a system and method for consumer engagement with a product and/or service via a marketing tool challenge and response challenge. In one embodiment, a mobile application can permit a consumer to create a private challenge which can be linked to a product and/or service. In the embodiment, the presence of the product and/or service can be a requirement for successful completion of the challenge. That is, the response to a challenge must reference the product and/or service to be eligible. A private challenge can be conveyed to one or more participants who can record video responses to the challenge related to the product and/or service. The challenge can include multiple criteria for successful completion including, but not limited to, a timed duration, a mandatory presentation of a secondary product or service within the video, a location, and the like.

A first challenge can be conducted within a consumer engagement mobile application. A component of the first challenge can be a good or a service of the sponsor. Each participant in the challenge must complete an act involving the good or the service component of the challenge. Each participant must create a visual record of the act. Each participant must submit the visual record of the act at a first specified time period. An invitation can be conveyed to participate in the challenge to each participant valid for the duration of the first specified time period. Each participant can create the visual record of the act, responsive to accepting the invitation within said first specified time period. A vote for at least one submitted visual record from the participant can be received upon closure of the first specified time period. The votes can be totaled to determine a winner of the challenge. The first specified time period is when entries close. During the first specified time period, the challenge/contest is viewed, users upload their video responses, and they are able to be viewed and voted upon. During a second time period, the winner of the challenge can be announced via the mobile application. There are only two time periods. Advantageously, all within the mobile application, private challenges/contests are provided, which allow users and sponsors to generate and set the terms of their own challenge/contest, as well as allow users and sponsors to engage in multiple concurrent challenges/contests.

A computer system can provide consumer engagement as a marketing tool, comprising a memory for storing instructions of one or more processors attached to the memory where the one or more processors are configured to execute a consumer engagement mobile application within a computing device. The device can be configured to conduct a first challenge within a consumer engagement mobile application. A component of the first challenge can be a good or a service of the sponsor. Each participant in the challenge must complete an act involving the good or the service component of the challenge. Each participant must create a visual record of the act. Each participant must submit the visual record of the act at a first specified time period. An invitation can be conveyed to participate in the challenge to each participant valid for the duration of the first specified time period. Each participant can create the visual record of the act, responsive to accepting the invitation within said first specified time period. A vote for at least one submitted visual record from the participant can be received in the first specified time period. The votes can be totaled to determine a winner of the challenge. The winner of the challenge can be announced via the mobile application.

A non-transitory computer-readable medium encoded with programming instructions that, when executed by a processor, cause the processor to perform the following steps. Visual records associated with conducting a first challenge within a consumer engagement mobile application can be stored within the medium. A component of the first challenge is a good or a service of the sponsor, wherein each participant in the challenge must complete an act involving the good or the service component of the challenge, wherein each the participant must create a visual record of the act, wherein each the participant must submit the visual record of the act at a first specified time period. An invitation to participate in the challenge can be transmitted to each the participant valid for the duration of the first specified time period. Access can be provided to accept the invitation to within the first specified time period, each the participant creating the visual record of the act. A vote can be received for at least one submitted visual record from the participant in the first specified time period. The votes can be computed to determine a winner of the challenge. The winner of the challenge can be notified via the mobile application.

### BRIEF DESCRIPTION OF THE SEVERAL VIEWS OF THE DRAWING

The novel features believed to be characteristic of this disclosure are set forth with particularity in the appended claims. The disclosure itself, however, both as to its organization and method of operation, together with further objects and advantages thereof, may best be understood by reference to the following description taken in connection with the accompanying drawings in which:

FIG. 1 is a general flow diagram of a system and method interactive consumer marketing tool residing entirely on a mobile application, according to a preferred embodiment of the present disclosure;

FIG. 2 is a relational diagram of the major components of the system and method of FIG. 1;

FIG. 3 depicts representative screen shot exemplars of user interfaces preferably associated with each step of the system of FIG. 1.

FIG. 4 is a general flow diagram of a system and method of consumer engagement marketing provided entirely on a mobile application, in accordance with the present disclosure;

FIG. 5 depicts representative screen shot exemplars of user interfaces preferably associated with each step of the system of FIG. 4, and provided entirely on a mobile application;

FIG. 6 depicts representative screen shot exemplars of user interfaces preferably associated with each step of the system of FIG. 4, and provided entirely on a mobile application;

FIG. 7 is a general flow diagram of a system and method of consumer engagement marketing provided entirely on a mobile application, in accordance with the present disclosure.

FIG. 8 is a general flow diagram of a system and method of consumer engagement marketing provided entirely on a mobile application, in accordance with the present disclosure.

FIG. 9 is a flow diagram of a system and method of consumer engagement marketing provided entirely on a mobile application, in accordance with the present disclosure.

### DETAILED DESCRIPTION OF THE DISCLOSURE

The non-limiting exemplary embodiment(s) will now be described more fully hereinafter with reference to the accompanying drawings, in which a preferred embodiment of the disclosure is shown. Such exemplary embodiment(s) may, however, be embodied in many different forms and should not be construed as limited to the embodiment set forth herein. Rather, these embodiment(s) are provided so that this application will be thorough and complete, and will fully convey the true scope of the disclosure to those skilled in the art.

The below disclosed subject matter is to be considered illustrative, and not restrictive, and any appended claim(s) are intended to cover all such modifications, enhancements, and other embodiment(s) which fall within the true scope of the non-limiting exemplary embodiment(s). Thus, to the maximum extent allowed by law, the scope of the non-limiting exemplary embodiment(s) is to be determined by the broadest permissible interpretation of the claim(s) and their equivalents, and shall not be restricted or limited by the foregoing detailed description.

References in the specification to “an exemplary embodiment”, “an embodiment”, “a preferred embodiment”, “an alternative embodiment” and similar phrases mean that a particular feature, structure, or characteristic described in connection with the embodiment(s) is included in at least an embodiment of the disclosure. The appearances of the phrase “a non-limiting exemplary embodiment” in various places in the specification are not necessarily all meant to refer to the same embodiment.

In one embodiment, the disclosure is directed toward one or more computer systems capable of carrying out the functionality described herein. It should be appreciated that a person of ordinary skill in the art can implement the disclosure utilizing a traditional computing device and/or computer system.

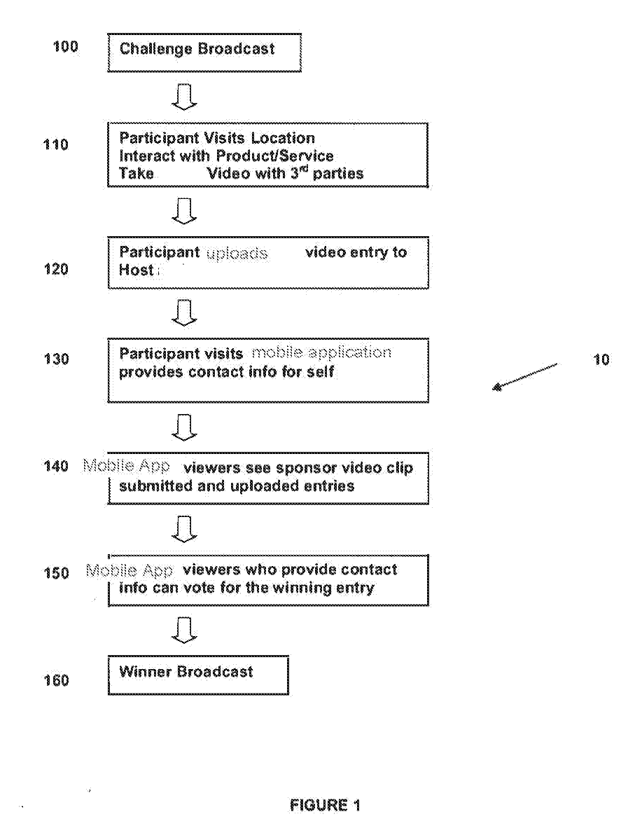

Referring to FIGS. 1-9, the mobile application 20 is a self-contained marketing tool. All challenges/events, functions, consumer-interaction, video display, voting, etc. occurs directly on the mobile application 20, and not a host website. Advantageously, all within the mobile application, private challenges/contests are provided, which allow users and sponsors to generate and set the terms of their own challenge/contest, as well as allow users and sponsors to engage in multiple concurrent challenges/contests. A computing device that may be used to implement any aspect of the functions described above. For example, a computing device may be used to implement any aspect of creating a challenge, performing video recording of a challenge response, and facilitating winner selection of the challenge. In all cases, a computing device represents one or more physical and tangible processing mechanisms.

Advantageously, non-limiting exemplary embodiments of the present disclosure provide a mobile application marketing tool that uploads, compresses, transcodes, and streams videos that users can select, vote, and comment on. The mobile application also includes databases that collect and analyze data. A computing device can include a communications infrastructure that transmits/receive information from processor, main memory, display interface, secondary memory, and communications interface, for example. Display interface can provide images on a display. The secondary memory may include a hard disk drive, removable storage drive and/or interface. Such components receive information from removable storage units. The communications interface transmits information via a communications conduit. Such information is transmitted/received from an external source via a communications path.

Each of the above methods may be executed using one or more processors on one or more computer devices. Embodiments may include various forms of distributed computing, client/server computing, and cloud based computing. Further, it will be understood that for each flow chart in this disclosure, the depicted steps or boxes are provided for purposes of illustration and explanation only. The steps may be modified, omitted, or re-ordered and other steps may be added without departing from the scope of this disclosure. Further, each step may contain one or more sub-steps. While the foregoing drawings and description set forth functional aspects of the disclosed systems, no particular arrangement of software and/or hardware for implementing these functional aspects should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. Each element of the block diagrams and flowchart illustrations, as well as each respective combination of elements in the block diagrams and flowchart illustrations, illustrates a function, step or group of steps of the methods, apparatus, systems, computer program products and/or computer-implemented methods. Any and all such functions may be implemented by computer program instructions, by special-purpose hardware-based computer systems, by combinations of special purpose hardware and computer instructions, by combinations of general purpose hardware and computer instructions, by a computer system, and so on. Any and all of which may be generally referred to herein as a “circuit,” “module,” or “system.”

A programmable apparatus which executes any of the above-mentioned computer program products or computer implemented methods may include one or more processors, microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computing device may include a computer program product from a computer-readable storage media and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present disclosure are not limited to applications involving conventional computer programs or programmable apparatus that run them. It is contemplated, for example, that embodiments of the presently claimed disclosure could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized. The computer readable medium may be a non-transitory computer readable medium for storage. A computer readable storage medium may be electronic, magnetic, optical, electromagnetic, infrared, semiconductor, or any suitable combination of the foregoing. Further computer readable storage medium examples may include an electrical connection having one or more wires, a portable computer diskette, a hard disk, a random access memory (RAM), a read-only memory (ROM), an erasable programmable read-only memory (EPROM), Flash, MRAM, FeRAM, phase change memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present disclosure may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the entity causing the step to be performed.

The mobile application 20 is a self-contained marketing tool. All challenges/events, functions, consumer-interaction, video display, voting, etc. occurs directly on the mobile application 20 and not a host website. In one general aspect, the system and method of interactive consumer marketing of the present disclosure provides for centralized database collection of specific target consumer information. Thus, the system and method of the present disclosure preferably defines a secure process capable of performing as a vehicle for creating a database of consumer data. Exemplary data comprise, by way of example and without limitation, names, addresses, mailing addresses, telephone numbers, product interests, and the like. According to the preferred embodiment of the present disclosure, as will be further discussed herein below, the database may be subdivided or categorized according to the source of engagement of the consumer interaction, the product or sponsor that was the focus of the consumer interaction, or any other reasonably useful and desirable data division.

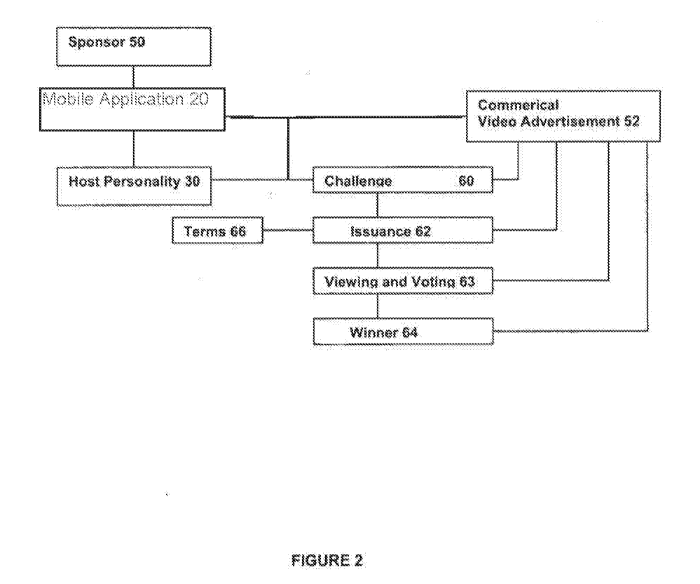

Referring now to FIG. 1, the general flow of system and method of interactive consumer marketing 10, according to a preferred embodiment of the present disclosure, comprises steps that occur and are completed within a twenty-four-hour time span. Supportive features required for execution of system and method of interactive consumer marketing 10 preferably include mobile application 20, host personality 30, communication means 40, sponsor 50, and challenge 60 as represented in FIG. 2.

The mobile application 20 is a self-contained marketing tool. All challenges/events, functions, consumer-interaction, video display, voting, etc. occurs directly on the mobile application 20 and not a host website. Advantageously, all within the mobile application, private challenges/contests are provided, which allow users and sponsors to generate and set the terms of their own challenge/contest, as well as allow users and sponsors to engage in multiple concurrent challenges/contests. Preferably, system and method of interactive consumer marketing 10 is much like a challenge/event, stimulating the viewer and/or participant in the manner of a challenge show. Mobile application 20 is maintained on cloud servers. Mobile application 20 is preferably non-branded other than as related to interactive marketing system and method 10.

In the preferred embodiment, mobile application 20 is preferably leased to sponsor 50 for a period of one day. During the relevant twenty-four-hour period, visitors to mobile application 20 will access an environment that is populated by the branding of sponsor 50 because mobile application 20 is preferably an adaptable template regularly and repeatedly uploaded with new brand information according to that day's sponsor 50. Thus, in the preferred embodiment, each day that a visitor accesses mobile application 20, a new sponsor's marketing materials will be displayed thereon.

Referring again to FIG. 2, the preferred system and method of interactive consumer marketing 10 begins at a specified time, wherein a five-minute live broadcast 62 is hosted by host personality 30 and is distributed via the mobile application 20 (e.g., smart phones). The mobile application 20 is a self-contained marketing tool. All challenges/events, functions, consumer-interaction, video display, voting, etc. occurs directly on the mobile application 20 and not a host website.

It should be understood by one skilled in the art that although such means of distribution are the preferred means for maximizing the benefits of system and method of interactive consumer marketing 10, any suitable communication means 40, or combination thereof, may alternately be utilized.

Preferably, a challenge can be of any length, and can begin at any time. Thus, any desirable time could be utilized, via the mobile application 20.

Moreover, although a five-minute presentation format is preferred for introduction of challenge 60 by host personality 30, other lengths may be utilized, either longer or shorter, as desired, without departing from the overall intended scope of the present disclosure. Preferably, host personality 30 sets the stage for challenge 60, building excitement for the audience prior to releasing the terms 66 of challenge 60 of sponsor 50. Then, sponsor commercial or video advertisement 52 is broadcast, wherein the subject goods or services thereof are preferably the focus of challenge 60. Host personality 30 further excites the viewers/consumers, preferably by offering a clue, or plurality of clues, and then specifies the detailed terms 66 of challenge 60, as specifically related to sponsor 50.

Thus, challenge 60 is preferably defined according to the specific sponsor 50 of mobile application 20 for the day the challenge 60 is issued. Nevertheless, the object of each challenge 60, irrespective of the sponsor 50, is to send in a visual confirmation 5, preferably a video, showing the successful completion of the specific terms 66 of challenge 60 within the required time, preferably 24 hours. That is, according to the preferred parameters for system and method 10, the video entry is displayed on mobile application 20 and to five 10 friends by 10:23 am PST; all of this happens directly on the mobile application 20. Exemplary terms 66 for challenge 60 that could be suitable for a particular sponsor 50 are, without limitation, as follows: (1) sponsor 50 is the U.S. ARMY and terms 66 for challenge 60 require 15 submission of a video of the entrant with two friends, taken inside an ARMY recruiting office; (2) sponsor 50 is MCDONALDS and terms 66 for challenge 60 require submission of a video of the entrant with one friend eating breakfast at a MCDONALDS restaurant; (3) sponsor 50 is GENERAL MOTORS and terms 66 for challenge 60 20 require submission of a video of the entrant sitting behind the wheel of a GMC ACADIA on a GMC dealer lot; (4) sponsor 50 is TROPICANA FOODS and terms 66 for challenge 60 require submission of video of the entrant posing in a supermarket with two TROPICANA products; (5) sponsor 50 is BUDWEISER and terms 66 for challenge 60 require submission of a video of “where do you keep your BUD?”; (6) sponsor 50 is AMERICAN AIRLINES and terms 66 for challenge 60 require submission of a video of a public display of your thoughts and affection for AMERICAN AIRLINES; or (7) sponsor 50 is GEICO and terms 66 for challenge 60 require submission of a video of your best gecko impersonation. Of course, one skilled in the art will readily recognize that the foregoing are examples without limitation, and that the sponsor/challenge terms 66 may be defined according to essentially any desired focal points and/or impact preference of each sponsor 50. Through the completion of terms 66 of each challenge 60, potential consumers are preferably (1) introduced to the physical location of sponsor 50 and/or (2) physically presented and interactive with the goods and/or services of sponsor 50.

Further, depending upon the particular consumer segment that sponsor 50 is intending to engage with challenge 60, the terms 66 of challenge 60 may be more or less outlandish. It is a preferred feature of each challenge 60 that terms 66 are of such a nature that “buzz” or media attention may naturally occur as a result thereof. Such media attention further accomplishes another goal of preferred system and method of interactive consumer marketing 10, wherein broadcast and print media will further inform additional potential consumers regarding the goods or services of sponsor 50, prospectively engaging consumer interest therein, but at least garnering increased consumer awareness.

The mobile application 20 is a self-contained marketing tool. All challenges/events, functions, consumer-interaction, video display, voting, etc. occurs directly on the mobile application 20 and not a host website. Each challenge participant must visit mobile application 20 to complete the entry process. Thus, following completion of challenge terms 66, and before submission of an entry, each challenge participant must visit mobile application 20 to finalize the entry process, wherein each challenge participant must enter his/her name, in addition to other requirements posted directly on the mobile application 20. Further, according to the preferred format for system and method 10, each challenge participant must confirm that he/she agrees to be contacted with future offers and/or marketing materials and the like in order to qualify to win challenge 60. Still further, each entry video must preferably be agreed to become the property of sponsor 50. It should be noted that alternate embodiments are envisioned wherein third-parties indirectly participating with each challenge participant would similarly render their confirmation and/or authorization to receive future offers and/or marketing materials.

In a non-limiting exemplary embodiment, each sponsor 50 may access mobile application 20 for any time period, wherein mobile application 20 is branded accordingly. Preferably, the sponsor period begins and ends at at any time period. However, the sponsor 50 for the following calendar day challenge 60 could be released the evening prior to the issuance of the challenge 60. According to this alternate embodiment, excitement and buzz could build with knowledge of the sponsor 50 and discussion regarding potential terms 66 for challenge 60 the following day. Nonetheless, either way, at least from the initial morning challenge broadcast 62, sponsor commercial/video advertisement 52 occupies the home page for the duration of the entry period. Thus, after viewing the commercial/video advertisement 52 during morning challenge broadcast 62, each challenge entrant necessarily views the commercial/video advertisement 52 again while finalizing the entry.

The mobile application 20 is a self-contained marketing tool. All challenges/events, functions, consumer-interaction, video display, voting, etc. occurs directly on the mobile application 20 and not a host website. Preferably, successful entries are displayed at mobile application 20, wherein any viewer may elect to view same at any time. Because commercial/video advertisement 52 loops continuously on mobile application 20, each such viewer is again introduced/reintroduced to the goods or services of sponsor 50. Moreover, according to the preferred embodiment of the present disclosure, challenge participants and non-participants alike may view and vote on the challenge entries 63 in order to select the winner. Preferably, in such manner, even more potential consumers are made aware of the goods or services of sponsor 50. However, it is preferred that appropriate tracking and verification software facilitates verification that each IP address or web-enabled phone address is limited to only one successful vote. One aspect of this process, which also strategically allows for collection of further consumer contact database information, requires provision of name and contact data in order to vote.

During a second time period, a winner broadcast 64 occurs, in similar format as morning challenge broadcast 62, with host personality 30 excitedly reviewing the days, events, and announcing the day's challenge winner, wherein the winner preferably receives a prize from sponsor 50. Although any prize format may be utilized without departing from the intended scope of the present disclosure, one exemplary prize could be a cash prize. The prize commitment of sponsor 50, in addition to a sponsorship fee paid to the operators of mobile application 20, conforms to a desirable format with respect to investment outlay and return thereon, including product and sponsor exposure, in addition to actual direct purchases that may occur at the time or on the day of the challenge.

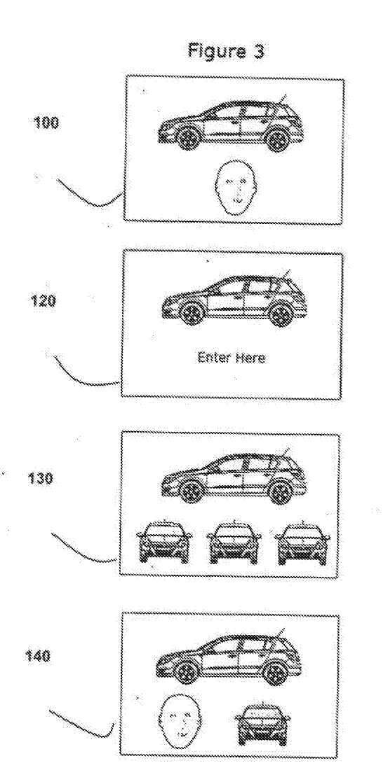

According to the preferred format for system and method of interactive consumer marketing 10, as exemplarily depicted in FIG. 3, mobile application 20 will thus be visited a minimum number of times by each challenge participant within the first specified time period, wherein each view will preferably be slightly different, but with the commonality of commercial/video advertisement 52 of sponsor 50, wherein at step 100, first viewing is at issuance of challenge 60; at step 130, a second viewing to complete entry; at step 150, to view other entries and vote; and, at step 160, to find out the winner. In such manner, in addition to the physical interaction and/or emotional engagement of completion of the challenge, and the undoubtedly frequent conversation of the entrant throughout the day, and even thereafter, regarding the challenge and the activities thereof, each entrant is exposed to the goods or services of sponsor 50 via a plurality of marketing channels and in a plurality of forms, and each entrant shares this knowledge, both during and likely after, the day of the challenge.

In another alternate embodiment, cameras could be strategically placed at locations related to the terms 66 of challenge 60 in order to capture the action that takes place following issuance of the challenge 60. The resulting footage could additionally populate mobile application 20 to generate additional interest, and could further becoming broadcast programming material, such as in the form of a weekly highlights program available on a television network, satellite, cable, webcast, or the like. The mobile application 20 is a self-contained marketing tool. All challenges/events, functions, consumer-interaction, video display, voting, etc. occurs directly on the mobile application 20 and not a host website.

Additionally, in an alternate embodiment noted hereinabove, mobile application 20 could convert branding a given time to the next day's sponsor 50. Such an alternate format could, for example, potentially generate sales of retail products prior to the issuance of the challenge 60 at the morning challenge webcast 62 as challenge participants attempt to anticipate the necessary “props” for completion of the next day's challenge. Another feature of such an alternate format is that the challenge 60 could require a product be videoed or video-recorded in an unexpected situation, such as, for example, on a particular mode of public transportation. Such a departure from a sponsor location could serve to expose the product and the challenge 60 issued by sponsor 50 to a further segment of the public population that may be otherwise unaware of either. The mobile application 20 is a self-contained marketing tool. All challenges/events, functions, consumer-interaction, video display, voting, etc. occurs directly on the mobile application 20 and not a host website.

The mobile application 20 is a self-contained marketing tool. All challenges/events, functions, consumer-interaction, video display, voting, etc. occurs directly on the mobile application 20 and not a host website. Advantageously, all within the mobile application, private challenges/contests are provided, which allow users and sponsors to generate and set the terms of their own challenge/contest, as well as allow users and sponsors to engage in multiple concurrent challenges/contests. According to the preferred steps in application of system and method of interactive consumer marketing 10, as depicted in FIG. 3, as noted, step 100 occurs upon webcast issuance of a challenge 60 that engages the interest of potential consumers. Step 110 (not shown) occurs wherein the challenge 60 requires potential consumers to be present at a physical location pre-selected by the sponsor 50 for presentation of goods and/or services, and/or requires specified consumer interaction with the goods and/or services of the sponsor within a specified time period. Preferably, the nature of the activities related to Step 110 encourages media event coverage and related broadcast of images and verbal identification of trademarks of the sponsor 50. Steps 120 (not shown), 130, 140 (not shown), and 150 follow, wherein the administration of, participation in, and observation of the challenge generates repeat traffic to a host site where consumer data is collected. Steps 120 and 130 occur, wherein participation in the challenge 60 requires consumer relay of further third-party consumer contact information for Step 120, with entry confirmation at Step 130. Involvement of mobile application 20 at steps 100, 130, 150, and 160 generates repeat access to the host site 20 for non-challenge participants by allowing for non-participants, as well as challenge participants.

The preferred inclusion of host personality 30, along with the specific time-element feature, preferably incorporated via the webcast times and the host mobile application 20, represent the preferred commonality for recognition and repeat traffic, irrespective of sponsor 50, and without detracting therefrom. Advantageously, all activities, functions, and user interactions occur directly on the mobile application 20. The mobile application 20 is a self-contained marketing tool. All challenges/events, functions, consumer-interaction, video display, voting, etc. occurs directly on the mobile application 20 and not a host website.

Additionally, in alternate embodiments, additional or different consumer information could be sought and/or obtained, as desired.

Further, in another alternate embodiment, mobile application 20 could be a selectable element or feature of an online forum, server, access provider landing page, file sharing site, or other Internet location that may e accessed by a plurality of individuals other than those participating in system and device 10. Of course, mobile application 20 may be downloaded via APPLE® and ANDROID® platforms.

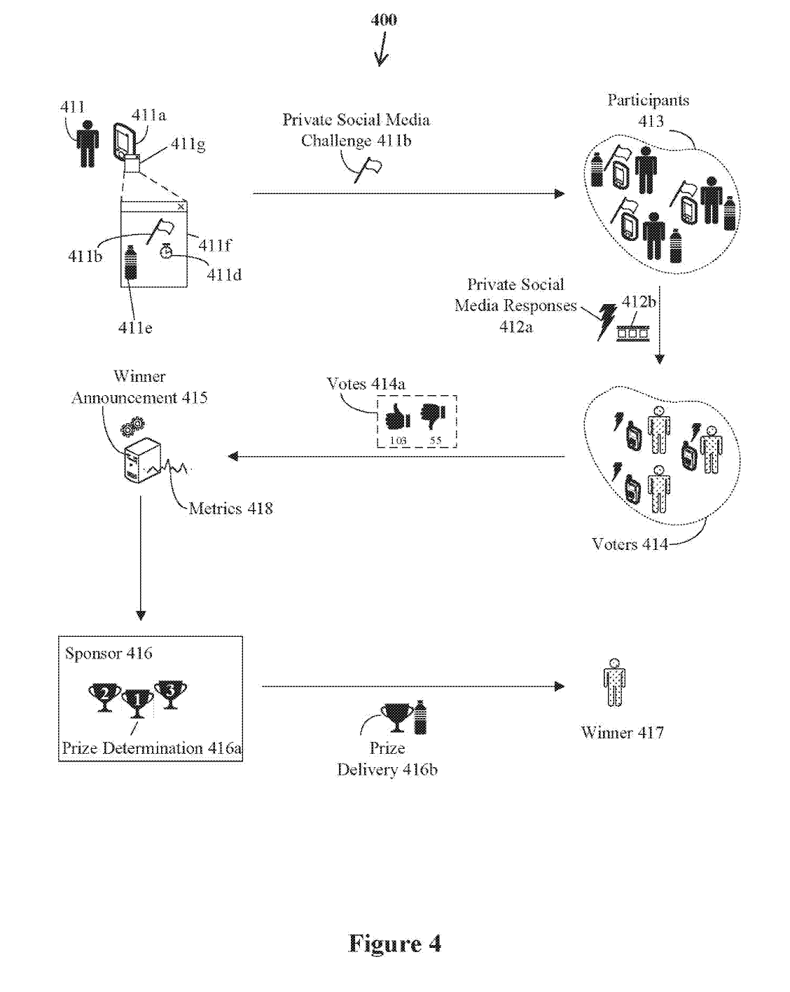

With reference to FIGS. 4-9, the mobile application 20 is a self-contained marketing tool. All challenges/events, functions, consumer-interaction, video display, voting, etc. occurs directly on the mobile application 20 and not a host website. Advantageously, all within the mobile application, private challenges/contests are provided, which allow users and sponsors to generate and set the terms of their own challenge/contest, as well as allow users and sponsors to engage in multiple concurrent challenges/contests. FIG. 4 is a general flow diagram of a system and method of consumer engagement marketing, in accordance with the present disclosure. In flow 400, a consumer 411 can interact with a mobile computing device 411a to create a private social media challenge 411b within a user interface 411f of device 411a. In one embodiment, challenge 411b can be associated with one or more sponsored products 411e. In the embodiment, the product 411e can be a mandatory criteria for the successful completion of a response to challenge 411b. In one instance, challenge 411b can include a video created by consumer featuring the product 411e. In the instance, consumer can set challenge attributes including, but not limited to, a set of participants 413, a location requirement, a timed duration, a mandatory presentation of a secondary product or service within the video, and the like. For example, a consumer, using mobile application 411g (e.g., TA-DAH®) can create a private challenge between a group of 400 friends within the consumer's social network which requires each of the 400 friends to make a video recording of themselves using the sponsored product 411e in a comedic and/or unorthodox way.

As used herein, a private challenge can be a multi-participant structured form of interaction with a product associated with a sponsor 416. Private challenge can include a set of selected participants chosen by a user 411. In one instance, private challenge participants can be selected by sponsor 416 (or another private user) to launch a new product, increase user awareness of an existing product, promote social responsibility through product usage, and the like. In one embodiment, private challenge can take the form of a recorded video which can be shared and/or presented to a set of selected participants of the private challenge. In the embodiment, responses generated from the challenge can be linked to the recorded video (e.g., cross-indexed within a database).

A sponsor 416 can be one or more organizations which can provide products and/or service. In one instance, a sponsor can be a retailer (e.g., AMAZON), a service provider, and the like. In one embodiment, sponsor 416 can be associated with one or more products 411e and/or services which can be referenced within private challenge 411b. In the embodiment, goods 411e can be visually present and/or can be mentioned by the challenge creator (e.g., user 411).

A product 411e can be an item that ideally satisfies a market's want or need. A product 411e can include, but is not limited to, raw materials, finish goods, and the like. In one instance, product 411e can include retail goods, wholesale goods, and the like. In one instance, product 411e can be associated with product coupons, vouchers, and the like.

Challenge 411b can include, but is not limited to, a recorded video of a challenge statement, a challenge completion criteria, a timed duration, a sponsor, metrics, votes, and the like.

When the challenge 411b creation is completed, the challenge 411b can be conveyed to one or more previously selected participants 413. Participants 413 can provide private social media responses 412a via one or more computing devices. For example, a participant 413 can create a video response 412b to the challenge 412 using a tablet which can be submitted through a like mobile application (e.g., 411g). In one instance, during the challenge, voters 414 can provide a vote 414a for each response 412a. In another instance, voters 414 can be prompted to vote on responses 412a upon expiration of the challenge deadline (e.g., timed duration). In the instance, a voting deadline can be instituted to ensure voters are allowed to vote before a winner is selected. In one embodiment, voters 414 can include all participants 413, can be a subset of participants, and the like.

Votes 414a can be computed during winner announcement 415 based one or more rules which can include a weighted value, non-weighted values, and the like. It should be appreciated that vote 414a collection, analysis, and the like can be performed utilizing traditional and/or proprietary processes. For example, vote 414a collection can be performed through the detection of user engagement mobile application 411g user interface selection. In one embodiment, one or more additional metrics 418 can be collected, analyzed, and/or utilized during the winner announcement 415 process or throughout the challenge process. In one instance of the embodiment, the metrics 418 can be utilized to target participants with a history of high levels of engagement, social network density (e.g., influencers), and the like.

In one instance, winner announcement 415 can be biased towards response length, participant 413 history, participant actions (e.g., sharing products on social media), and the like. It should be appreciated that winner announcement 415 can include multiple winners (e.g., a tie, first, second, third) or a single winner (e.g., winner 417). In one instance, winner announcement 415 can include manual steps and/or processes.

In one embodiment, prize determination 416a can be performed based on the outcome of winner announcement 415. In the embodiment, one or more previously established prices can be assigned to one or more winners. In one instance, prize determination 416a can include manual steps and/or processes. For example, a first place winner can receive a 3 month supply of a Product A, while a second place winner can receive a Product A coupon valid for one month, and a third place winner can receive a free Product B sample.

Once prizes are assigned to relevant one or more relevant winners (e.g., winner 417), the prize can be conveyed to winner 417 during prize delivery 416b. It should be appreciated that prize delivery can include delivery of physical goods to a physical location, physical good delivery for an electronic voucher, electronic delivery of voucher for physical goods, electronic delivery of electronic goods, and the like.

It should be appreciated that challenge 412 and/or responses 412a can include proprietary technologies which lock in content created by challenge 412/responses 412a. That is, video challenges and responses can be prohibited from being directly shared on social media through a proprietary encoding, a security mechanism, and the like.

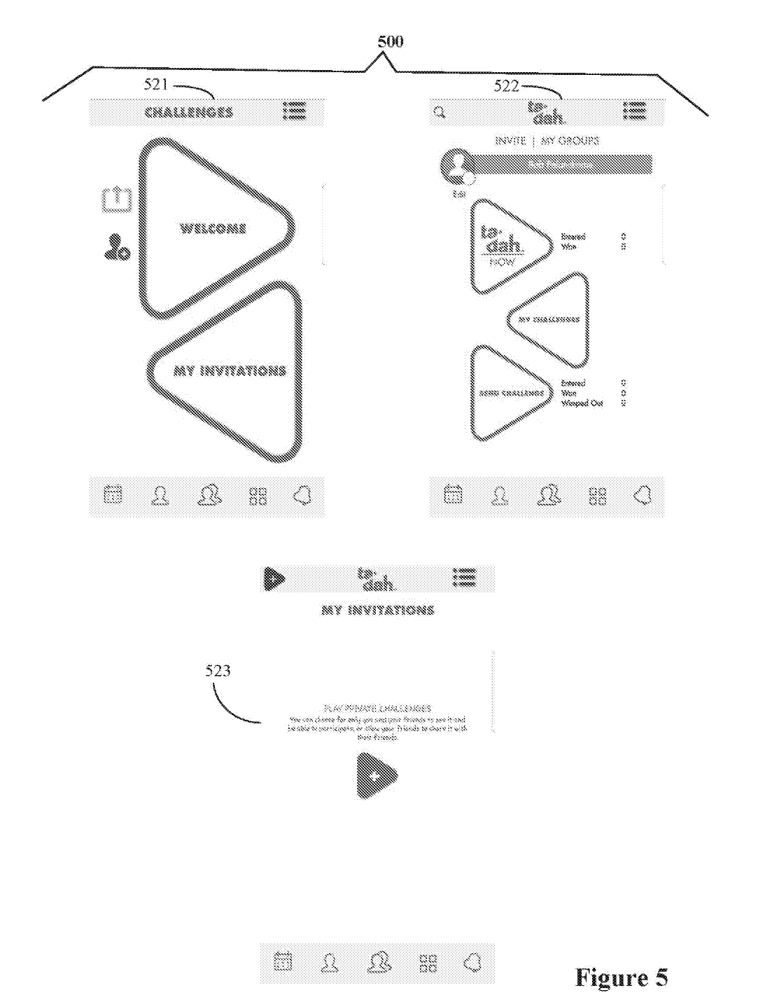

FIG. 5 depicts representative screen shot exemplars of user interfaces preferably associated with each step of the system of FIG. 2. Advantageously, all within the mobile application, private challenges/contests are provided, which allow users and sponsors to generate and set the terms of their own challenge/contest, as well as allow users and sponsors to engage in multiple concurrent challenges/contests.

In screen shot exemplar 521, a home screen can include one or more user interface elements 521a, 521b. Element 521a can include an introduction content, such as a tutorial, short video explanation, and the like. Element 521b can trigger the presentation of a participation invitation screen to participate in a private challenge.

In screen shot exemplar 522, a user dashboard screen can present relevant user statistics, user interface elements for initiating a private challenge, viewing current private challenges, and the like.

In screen shot exemplar 523, a user interface element 523a can permit the creation of a new private challenge. In one instance, selection of user interface element 523a can trigger the presentation of a video recording functionality (e.g., system camera) which can permit a user to record a short video of a new challenge.

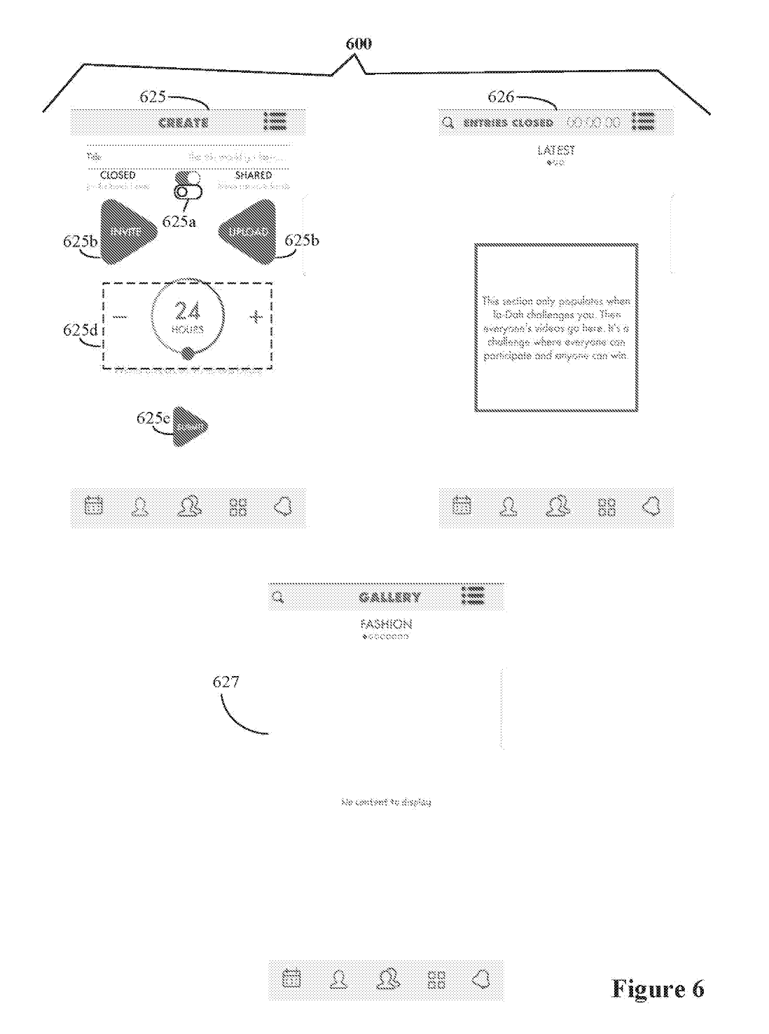

FIG. 6 depicts representative screen shot exemplars of user interfaces preferably associated with each step of the system of FIG. 2.

Advantageously, all within the mobile application, private challenges/contests are provided, which allow users and sponsors to generate and set the terms of their own challenge/contest, as well as allow users and sponsors to engage in multiple concurrent challenges/contests. The mobile application 20 is a self-contained marketing tool. All challenges/events, functions, consumer-interaction, video display, voting, etc. occurs directly on the mobile application 20 and not a host website. The private challenge/contest function is unique. The creator of a private challenge can choose their own challenge/contest, the duration of the challenge (e.g., 1-48 hours), who they invite to the challenge/contest, and whether they allow the people they invite to invite other people, or for the challenge/contest to remain closed to just the people they choose to invite. This can be used by “everyday people” or brands/products whom can receive additional features. All invitees have access to view the other invitees, there responses, and to comment and vote, thus creating favorites/winners. Users can create groups and conduct and participate in multiple challenges with different groups simultaneously. Again, the data collected, which invitees are connected to which invitees, and by what means, who participated/voted and for whom/commented/shared and with whom, are indicative of the data and analysis the present mobile application 20 system generates.

In screen shot exemplar 625, user interface elements 625a-d can be utilized to create a new private challenge. In one instance, a user interface element 625a can permit the selection of a challenge visibility. In the instance, the challenge can be set to private to allow only a user selected set of participants to see and participate in the challenge. User interface element 625b can permit a user to select a set of participants from one or more contact lists. For example, selection of element 625b can trigger the presentation of a mobile phone contact list and/or social media contact list. User interface 625c can allow a user to record a short video clip associated with the private challenge. The private challenge can be associated with a timed duration which can be configured within user interface element 625d. In user interface element 625d, a selection of a duration up to 24 hours can be selected for the challenge. In one instance, the time duration can be directly and/or indirectly linked to challenge rewards. For example, shorter durations can yield bigger rewards to encourage timely participation while longer durations can allow more participation yet still provide significant rewards. Submission of challenge and notification of challenge to participants can be triggered responsive to selection of user interface element 625d.

In screen shot exemplar 626, a set of current challenges which are open and visible to the user can be presented. In one instance, exemplar 626 can include historic challenges, missed challenges, and the like.

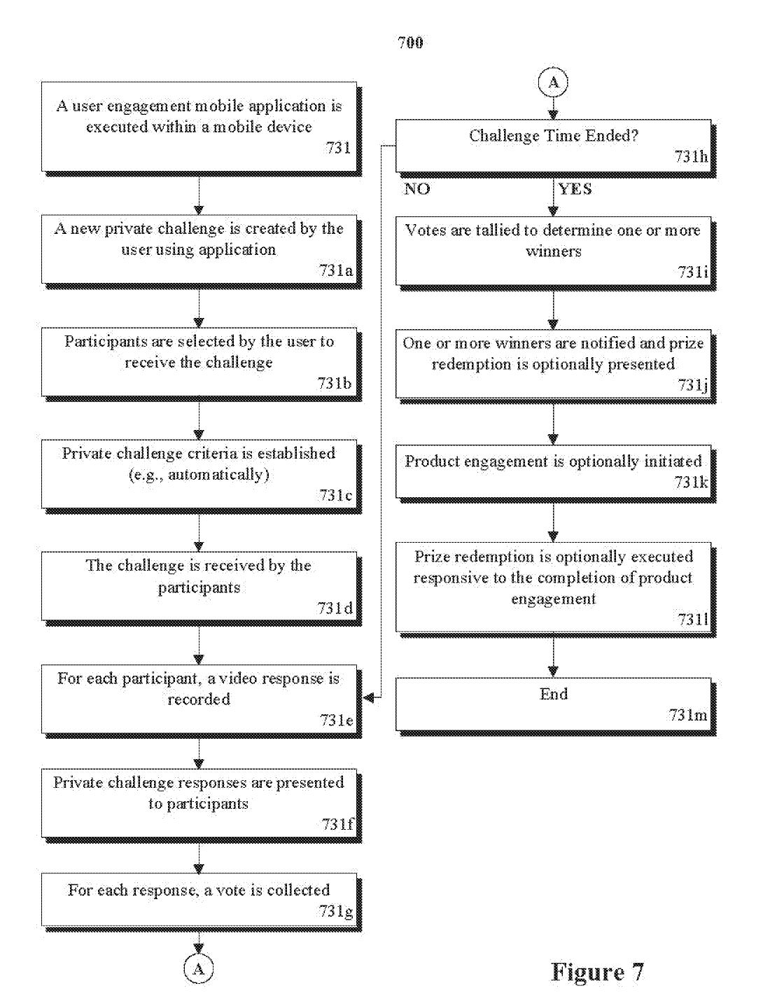

FIG. 7 is a general flow diagram of a system and method of consumer engagement marketing, in accordance with a non-limiting exemplary embodiment of the present disclosure.

In step 731, a user engagement mobile application can be executed within a mobile device. In step 731a, a new private challenge can be created by the user using the application. In step 731b, participants can be selected by the user to receive the challenge. In step 731c, the private challenge criteria can be established by the user. In step 731d, the challenge can be received the selected participants. In step 731e, for each participant, a video response can be recorded via an instance of mobile application executing on the mobile device used by the participant. In step 731f, private challenge responses can be presented to the participants. In step 731g, for each response, a vote can be collected. In step 731h, if the challenge is ended the method can continue to step 731i, else return to step 731e. In step 731i, votes can be tallied to determine one or more winners. In step 731j, one or more winners can be announced and/or notified and prize redemption can be optionally presented. In step 731k, product engagement can be optionally initiated. In step 731l, prize redemption can be optionally executed responsive to the completion of product engagement. In step 731m, the method can end.

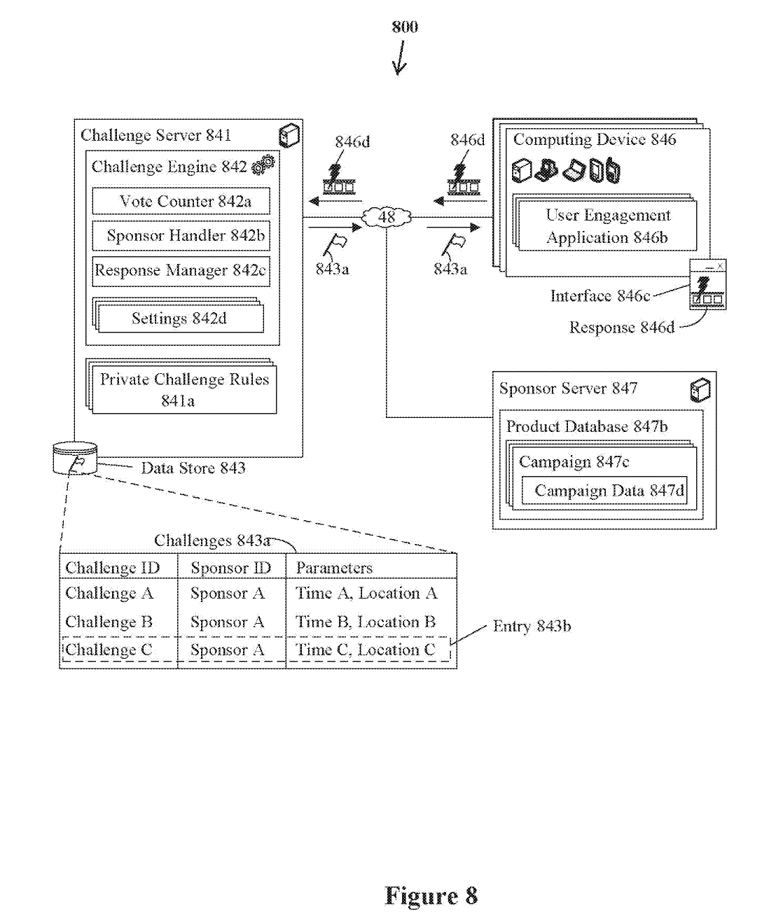

FIG. 8 is a general flow diagram of a system and method of consumer engagement marketing, in accordance with the present disclosure. System 800 can be present in the context of flow 400, and screen shot exemplars 500, 700. In system 800, a private challenge can be facilitated by engine 842 to generate user engagement with a product from a sponsor (e.g., via a sponsor server 47). Computing device 46 can be utilized to create challenge (e.g., 843b), provide responses 846d, and the like through the use of user engagement application 846b and/or system functionality of device 846. System 800 can be communicatively linked via network 848.

Challenge server 841 can include a hardware/software entity for executing challenge engine 842. Server 841 can include, but is not limited to, engine 842, private challenge rules 841a, data store 843, and the like. Server 841 functionality can include, but is not limited to, load balancing, encryption, authentication, authorization, and the like. In one instance, server 841 can be a component of a distributed computing environment, a networked computing environment, a cloud-based environment, and the like.

Challenge engine 842 can be a hardware/software element for facilitating challenge (e.g., entry 843b) creation, propagation, and/or completion. Engine 842 can include, but is not limited to, vote counter 842a, sponsor handler 842b, response manager 842c, settings 842d, and the like. In one embodiment, at least a portion of the engine 842 can be present within user engagement application 846b. In another embodiment, engine 842 can be a Web-based service which can provide the functionality of the disclosure via user engagement application 846b.

Vote counter 842a can be a hardware/software entity for collection of votes associated with a private challenge. In one instance, vote counter 842a can be utilized to verify single vote casting (e.g., detect duplicate users). In another instance, vote counter 842a can collect related metrics regarding user participation. For example, counter 842a can detect the number of tries a user performs before submitting a challenge response.

Sponsor handler 842b can be a hardware/software element for interfacing with sponsor server 847. In one instance, handler 842b can be utilized to query product database 847b to automate generate a list of challenges based on one or more campaign 847c and/or campaign data 847d. In the instance, based on active marketing campaigns being performed by a sponsor, one or more private challenges can be automatically created to challenge a specific demographic of users associated with the campaign (e.g., based on data 847d).

Response manager 842c can be a hardware/software entity for aggregating response 846d. Manager 842c functionality can include, but is not limited to, response 846d verification, response 846d rejection, and the like. In one instance, manager 842c can utilize private challenge rules 841a to perform the aforementioned functionality. For example, manager 842c can be utilized to detect participants attempting to “challenge” the system to obtain rewards over other participants. In one embodiment, manager 842c can be utilized to perform winner announcement through notifications, including, but not limited to, voice based notifications, text based notifications, and the like. Voice based notifications can include, but is not limited to, human agent initiated calls, automated calls, and the like. Text based notifications can include, but is not limited to, text exchange, Short Message Service (SMS), TWITTER® tweets, FACEBOOK® messages, and the like. In one instance, multimedia based notifications can be presented within user engagement application 846b. In the instance, a live video conferencing session between a winner and a host with an audience can be performed. For example, a celebrity host can assemble with an audience at a specified sponsor location and can initiate a SKYPE® call to a winner to announce the prize which has been won.

Settings 842d can be one or more rules for configuring the behavior of system 800 and/or system 800 components. Settings 842 can be automatically generated, manually generated, and the like. Settings 842 can include vote counter 842a options, sponsor handler 842b settings, response manager 842c options, and the like. In one instance, settings 842 can be heuristically generated from historic settings to create an engine 842 which can learn through machine learning algorithms. In one embodiment, settings 842d can be persisted within data store 843, device 846, server 847, and the like.

Private challenge rules 841a can be one or more computer readable settings and/or legal stipulations associated with a private challenge. In one instance, challenge rules 841a can be automatically generated, manually generated, and the like. In one embodiment, rules 841a can be persisted within data store 843, device 846, server 847, and the like.

Data store 843 can be a hardware/software component able to persist challenges 843a, response 846d, private challenge rules 841a, and the like. Data store 843 can be a Storage Area Network (SAN), Network Attached Storage (NAS), and the like. Data store 843 can conform to a relational database management system (RDBMS), object oriented database management system (OODBMS), non-relational database management systems, and the like. Data store 843 can be communicatively linked to server 841 in one or more traditional and/or proprietary mechanisms. In one instance, data store 843 can be a component of Structured Query Language (SQL) complaint database.

Challenges 843a can be a group of private challenges (e.g., 843b) stored within a computer readable medium. Challenges 843a can include, but is not limited to, a challenge identifier, a sponsor identifier, one or more challenge parameters, and the like. It should be appreciated that challenge parameters can be indexed (e.g., within a referential database) via one or more identifiers and is included within table 843a for the sake of clarity. In one instance, a challenge (e.g., 843b) can be persisted within a database which can link numerous elements associated with the challenge including, challenge name, challenge descriptor, challenge creator, sponsor name, sponsor marketing campaign, sponsor product/service, challenge time duration, challenge location, additional challenge parameters, responses, and the like.

Computing device 846 can be a hardware/software element for permitting the execution of user engagement application 846b. Device 846 can include, but is not limited to, interface 846c, device 846 settings, and the like. Computing device 846 can include, but is not limited to, a desktop computer, a laptop computer, a tablet computing device, a personal digital assistant (PDA), a mobile phone, a set-top box, and the like. In one embodiment, device 846 can include audio/video input components, including, but not limited to, a microphone, a camera, and the like. In one instance, device 846 can include, but is not limited to, a gaming console, an entertainment device, and the like. In one instance, interface 846c can present challenge 843b content, response 846d, and the like.

Sponsor server 847 can be a hardware/software entity for providing data 847d associated with challenge 843a. Server 847 can include, but is not limited to product database 847b, campaign 847c, campaign data 847d, and the like. In one instance, sponsor server 847 can include a 3^{rd} party server which can provide a marketing platform configured to interface with multiple user engagement endpoints (e.g., WEBENGAGE™, MINDTOUCH™, LIVEPERSON™, EGAIN™). In one instance, database 847b can include campaign data 847d for all relevant campaigns which sponsor 847 seek to engage users. Campaign data 847d can include, but is not limited to, product identifiers, product exclusions, demographics, product costs, campaign budget, referral fees, and the like.

Network 848 can be an electrical and/or computer network connecting one or more system 800 components. Network 848 can include, but is not limited to, twisted pair cabling, optical fiber, coaxial cable, and the like. Network 848 can include any combination of wired and/or wireless components. Network 848 topologies can include, but is not limited to, bus, star, mesh, and the like. Network 848 types can include, but is not limited to, Local Area Network (LAN), Wide Area Network (WAN), Virtual Private Network (VPN) and the like.

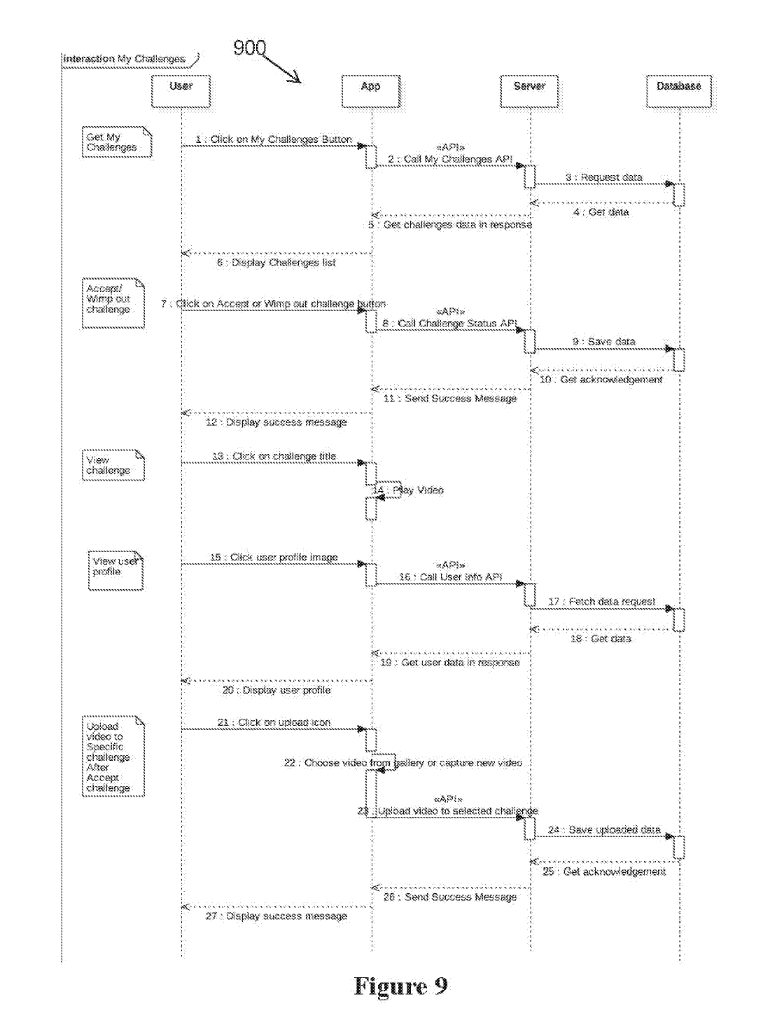

FIG. 9 is a flow diagram of a system and method of consumer engagement marketing, in accordance with the present disclosure. System 900 can be present in the context of flow 900, wherein a relational methodology is illustrated between a user, the app, the server, and the database. Five processes are described wherein the first process is “getting my challenges,” the second process is “accepting/wimping out of challenge,” the third process is “viewing the challenge,”, the fourth process is “viewing the user profile,” and the fifth process is “uploading the video after accepting the challenge.” Such processes are provided by the interaction between the user and the depicted hardware/software.

There has thus been outlined, rather broadly, the more important features of the disclosure in order that the detailed description thereof that follows may be better understood, and in order that the present contribution to the art may be better appreciated.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the disclosure of the application, nor is it intended to be limiting as to the scope of the disclosure in any way.

What is claimed as new and what is desired to secure by Letters Patent of the United States is:

1. A computer implemented method for consumer engagement comprising:
conducting at least one challenge entirely within a consumer engagement mobile application, wherein a component of said first challenge is a good, a service, or a task, wherein each participant in said challenge must complete an act involving said good, said service, or said task component of said challenge, wherein each said participant must create a visual record of said act, wherein each said participant must submit said visual record of said act at a first specified time period;
conveying an invitation, entirely within said consumer engagement mobile application, to participate in said challenge to each said participant valid for said duration of said first specified time period;
responsive to accepting said invitation within said first specified time period, entirely within said consumer engagement mobile application, each said participant creating said visual record of said act;
receiving a vote for at least one submitted visual record from said participant, during said first specified time period and entirely within said consumer engagement mobile application;
totaling of said votes, during said first specified time period and entirely within said consumer engagement mobile application, to determine a winner of said challenge; and
announcing said winner of said challenge, during a second specified time period beginning after said first specified time period and entirely within said consumer engagement mobile application.

2. The computer implemented method of claim 1, wherein said at least one challenge comprises: a sponsored challenge, wherein said component of said sponsored challenge is said good or said service.

3. The computer implemented method of claim 1, wherein said at least one challenge is a private challenge, wherein said component of said private challenge is said task.

4. The computer implemented method of claim 1, wherein said at least one challenge comprises: each of a sponsored challenge and a private challenge, wherein said component of said sponsored challenge is one of said good or said service, wherein said component of said private challenge is said task.

5. The computer implemented method of claim 4, wherein said sponsored challenge and said private challenge occur in chronological order.

6. The computer implemented method of claim 1, further comprising:
awarding a prize to said winner, during said second specified time period and entirely within said consumer engagement mobile application.

7. The computer implemented method of claim 1, wherein the awarding is performed responsive to a different act involving said good or said service component.

8. The computer implemented method of claim 1, wherein said act involving said good or service of said sponsor further comprises interactive engagement with said good or said service.

9. The computer implemented method of claim 1, wherein said interactive engagement is selected from the group consisting of physical interaction and emotional interaction.

10. The computer implemented method of claim 1, wherein said challenge is announced via the consumer engagement mobile application.

11. The computer implemented method of claim 1, further comprising the step of: providing said sponsor a means to monitor metrics associated with said challenge.

12. A computer system for providing consumer engagement comprising:
a memory for storing instructions; one or more processors attached to the memory wherein the one or more processors are configured to:
execute a consumer engagement mobile application within a computing device configured to conduct a challenge entirely within a consumer engagement mobile application, wherein a component of said first challenge is a good, a service, or a task, wherein each participant in said challenge must complete an act involving said good, said service, or said task component of said challenge, wherein each said participant must create a visual record of said act, wherein each said participant must submit said visual record of said act at a first specified time period;
convey an invitation, entirely within said consumer engagement mobile application, to participate in said challenge to each said participant valid for the duration of the first specified time period;
accept said invitation within said first specified time period, entirely within said consumer engagement mobile application, each said participant creating said visual record of said act;
receive a vote for at least one submitted visual record from said participant during said first specified time period and entirely within said consumer engagement mobile application;
total said votes, during said first specified time period and entirely within said consumer engagement mobile application, to determine a winner of said challenge; and
announce said winner of said challenge, during a second specified time period beginning after said first specified time period and entirely within said consumer engagement mobile application, via said mobile application.

13. The computer system of claim 9, further comprising:
awarding a prize to said winner, during said second specified time period and entirely within said consumer engagement mobile application.

14. The computer system of claim 9, wherein the awarding is performed responsive to a different act involving said good, said service, or said task component via said mobile application.

15. The computer system of claim 9, wherein said act involving said good or service of said sponsor further comprises interactive engagement with said good, said service, or said task via said mobile application.

16. The computer system of claim 9, wherein said interactive engagement is selected from the group consisting of physical interaction and emotional interaction.

17. The computer system of claim 9, wherein said challenge is announced via said consumer engagement mobile application.

18. The computer system of claim 9, further comprising the step of: providing said sponsor a means to monitor metrics associated with said challenge, wherein said metrics is obtained from said mobile application.

19. A non-transitory computer-readable medium encoded with programming instructions that, when executed by a processor, cause the processor to performs the following steps:
store a plurality of visual records associated with conducting a challenge entirely within a consumer engagement mobile application, wherein a component of said first challenge is said good, said service, or said task, wherein each participant in said challenge must complete an act involving said good or said service component of said challenge, wherein each said participant must create a visual record of said act, wherein each said participant must submit said visual record of said act at a first specified time period;
transmit an invitation, entirely within said consumer engagement mobile application, to participate in said challenge to each said participant valid for said duration of said first specified time period;
provide access to accept said invitation within said first specified time period, entirely within said consumer engagement mobile application, each said participant creating said visual record of said act;
receive a vote for at least one submitted visual record from said participant during said first specified time period and entirely within said consumer engagement mobile application;
computing said votes, during said first specified time period and entirely within said consumer engagement mobile application, to determine a winner of said challenge; and
notifying said winner of said challenge, during a second specified time period beginning after said first specified time period and entirely within said consumer engagement mobile application.

20. The computer-readable medium of claim 17, wherein programming instructions that, when executed by a processor, enable viewing and interfacing of the accessed data, cause the processor to perform the following steps:
award a prize to said winner, during said second specified time period and entirely within said consumer engagement mobile application, via a digital download.
